(19) United States
(12) Patent Application Publication
(10) Pub. No.: US 2018/0262809 A1
(43) Pub. Date: Sep. 13, 2018

(54) Method and Device for switching Broadcast TV Program to on-demand Program

(71) Applicants: LE HOLDINGS (BEIJING) CO., LTD., Beijing (CN); LE SHI INTERNET INFORMATION & TECHNOLOGY, Beijing (CN)

(72) Inventor: Liang LI, BEIJING (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/119,863

(22) PCT Filed: May 26, 2016
(86) PCT No.: PCT/CN2016/083545

§ 371 Date: Aug. 18, 2016

(30) Foreign Application Priority Data
Nov. 27, 2015 (CN) 201510847924.X

(51) Int. Cl. H04N 21/472; H04N 21/647; H04N 21/222

(52) U.S. Cl. CPC H04N 21/47202; H04N 21/222; H04N 21/64723

(57) ABSTRACT

Disclosed is a method and device for switching broadcast TV program to on-demand program, comprising the steps of: receiving a TV signal switching instruction; recording a current playing time of a current broadcasting TV program of broadcast TV signals; analyzing the TV program of broadcast TV signals and obtaining a VOD (Video on-Demand) pathway of network resource which matches with the TV program of broadcast TV signals; determining a target playing time point of a video program corresponding to a VOD pathway based on the current playing time; and acquiring the VOD pathway and starting to play a corresponding video program from the target playing time point.

### CROSS-REFERENCE TO RELATED APPLICATIONS

This application is a continuation of International Application No. PCT/CN2016/083545, filed on May 26, 2016, which is based upon and claims priority to Chinese Patent Application No. 201510847924X, filed on Nov. 27, 2015, the entire contents of which are incorporated herein by reference.

### TECHNICAL FIELD

The present disclosure relates to television signal processing technology, in particular to a method and device for switching broadcast TV program to on-demand program.

### BACKGROUND

Broadcast television signals (hereinafter referred to as broadcast TV signals), as the current common television signals employed by domestic households, plays a very important role in the people's family lives. The broadcast TV signals includes satellite TV signals and digital TV signals. When using the two TV signals, since the programs of each TV station have to be broadcasted according to the program schedules of the TV station itself, users cannot intervene the program process based on their own wishes. For example, when the TV station interrupts a TV drama with advertising spots, since users cannot control the ordinary broadcast TV signals, they only can wait for the end of advertising spots to continue to watch.

How to find a solution to achieve that users can not only watch TV programs of broadcast TV signals based on their own preferences, but also freely choose a TV drama to watch when they are unlike to watch the advertising spots, which is a problem urgently awaiting to be solved at present.

### SUMMARY

In view of this, an object of an embodiment of the present disclosure is to provide a method and device for switching broadcast TV program to on-demand program, for switching a broadcast program to an on-demand program based on the user's request, so that the user can continue to watch the program without need to wait for the end of advertising spots.

Based on the above-described object of the embodiment of the present disclosure, it is provided a method for switching broadcast TV program to on-demand program, including:
receiving a TV signal switching instruction;
recording a current playing time of a current broadcasting TV program of broadcast TV signals;
analyzing the TV program of broadcast TV signals and obtaining a VOD (Video on-Demand) pathway of network resource which matches with the TV program of broadcast TV signals;
determining a target playing time point of a video program corresponding to a VOD pathway based on the current playing time; and
acquiring the VOD pathway and starting to play a corresponding video program from the target playing time point.

In some alternative embodiments, the step of analyzing the TV program of broadcast TV signals and obtaining a VOD pathway of network resource which matches with the TV program of broadcast TV signals includes:
obtaining a station logo of a current broadcasting TV station by analyzing a screen of the TV program of broadcast TV signals;
acquiring a program list of the TV station corresponding to the station logo based on the obtained station logo;
obtaining a program information of the TV program of broadcast TV signals by analyzing the program list;
obtaining a video program corresponding to the program information by matching in a network media repository;
extracting a VOD pathway of the video program from the network media repository.

In some alternative embodiments, the step of determining a target playing time point of a video program corresponding to a VOD pathway based on the current playing time includes the steps of:
acquiring a starting time of the current broadcasting TV program of broadcast TV signals from the program list;
acquiring a played duration by subtracting the starting time from the current playing time;
taking a final time point of the played duration as a target playing time point.

In some alternative embodiments, before the step of receiving a TV signals switching instruction, the method further includes:
detecting that the current broadcasting TV program of broadcast TV signals is starting to be cut in by advertising spots;
sending a prompt message of whether switching the TV signals or not.

In some alternative embodiments, the prompt message of whether switching the TV signals or not includes:
a duration of the advertising spots;
a name of the current broadcasting TV program; and
a left duration of the current broadcasting TV program.

Another aspect of embodiments of the present disclosure provides a device for switching broadcast TV program to on-demand program, comprising:
a signal receiving module, for receiving a TV signal switching instruction;
a playing time recording module, for recording a current playing time of a current broadcasting TV program of broadcast TV signals;
a VOD pathway matching module, for analyzing the TV program of broadcast TV signals and obtaining a VOD pathway of network resource which matches with the TV program of broadcast TV signals;
a target playing time point determining module, for determining a target playing time point of a video program corresponding to a VOD pathway based on the current playing time; and
a video program playing module, for acquiring the VOD pathway and starting to play a corresponding video program from the target playing time point.

In some alternative embodiments, the VOD pathway matching module includes:
a screen analyzing unit, for obtaining a station logo of a current broadcasting TV station by analyzing a screen of the TV program of broadcast TV signals;
a program list acquiring unit, for acquiring a program list of the TV station corresponding to the station logo based on the obtained station logo;
a program list analyzing unit, for obtaining a program information of the TV program of broadcast TV signals by analyzing the program list;
a video program matching unit, for obtaining a video program corresponding to the program information by matching in a network media repository;
a VOD pathway extracting unit, for extracting a VOD pathway of the video program from the network media repository.

In some alternative embodiments, the target playing time point determining module includes:
a starting time acquiring unit, for acquiring a starting time of the current broadcasting TV program of broadcast TV signals from the program list;
a played duration acquiring unit, for acquiring a played duration by subtracting the starting time from the current playing time; and
a target playing time point determining unit, for taking a final time point of the played duration as a target playing time point.

In some alternative embodiments, the device further includes:
an advertising monitoring module, for detecting that the current broadcasting TV program of broadcast TV signals is starting to be cut in by advertising spots; and
a switching prompting module, for sending a prompt message of whether switching the TV signals or not.

In some alternative embodiments, the prompt message of whether switching the TV signals or not includes:
a duration of the advertising spots;
a name of the current broadcasting TV program; and
a left duration of the current broadcasting TV program.

Further another aspect of an embodiment of the present disclosure further provides a device, comprising:
one or more processor(s); and
a memory for storing one or more operating instruction(s);
wherein the one or more processor(s) is/are configured to acquire the operation instruction from the memory to execute the steps of:
receiving a TV signal switching instruction;
recording a current playing time of a current broadcasting TV program of broadcast TV signals;
analyzing the TV program of broadcast TV signals and obtaining a VOD (Video on-Demand) pathway of network resource which matches with the TV program of broadcast TV signals;
determining a target playing time point of a video program corresponding to a VOD pathway based on the current playing time; and
acquiring the VOD pathway and starting to play a corresponding video program from the target playing time point.

In some alternative embodiments, the processor is further used for executing the steps of:
obtaining a station logo of a current broadcasting TV station by analyzing a screen of the TV program of broadcast TV signals;
acquiring a program list of the TV station corresponding to the station logo based on the obtained station logo;
obtaining a program information of the TV program of broadcast TV signals by analyzing the program list;
obtaining a video program corresponding to the program information by matching in a network media repository; and
extracting a VOD pathway of the video program from the network media repository.

In some alternative embodiments, the processor is further used for executing the steps of:
acquiring a starting time of the current broadcasting TV program of broadcast TV signals from the program list;
acquiring a played duration by subtracting the starting time from the current playing time; and
taking a final time point of the played duration as a target playing time point.

In some alternative embodiments, the process is further used for executing the steps of:
detecting that the current broadcasting TV program of broadcast TV signals is starting to be cut in by advertising spots; and
sending a prompt message of whether switching the TV signals or not.

In some alternative embodiments, the prompt message of whether switching the TV signals or not includes:
a duration of the advertising spots;
a name of the current broadcasting TV program; and
a left duration of the current broadcasting TV program.

As can be seen from the above, the method and device for switching broadcast TV program to on-demand program provided by the embodiments of the present disclosure, can record the current playing time and find the network resource corresponding to the current broadcasting TV program by responding to the received TV signal switching instruction, and resume to play the corresponding VOD program from the time point when receiving the switching instruction, so that when the broadcast TV program is cut in by advertising spots, the user can search the network resource to resume the playback by himself without waiting for the end of the advertising spots, which may facilitate the user to watch the TV program of interest and save the user's time of waiting for the end of advertising.

It should be understood that both the descriptions in general and in detailed are exemplary and explanatory without any limit to the disclosure.

### BRIEF DESCRIPTION OF DRAWINGS

In order to more clearly illustrate the embodiments of the present disclosure, the drawings as required for illustrating the embodiments will be described in brief. Apparently, the drawings described below are merely some embodiments of the present disclosure, and for the ordinary skilled in the art can learn from the drawings without creative efforts.

FIG. 1 is a schematic flow diagram of a method for switching broadcast TV program to on-demand program according to some embodiments of the present disclosure;

FIG. 2 is a schematic flow diagram of a method for switching broadcast TV program to on-demand program according to some embodiments of the present disclosure;

FIG. 3 is a schematic block diagram showing a device for switching broadcast TV program to on-demand program according to some embodiments of the present disclosure;

FIG. 4 is a schematic block diagram showing a VOD pathway matching module in a device for switching broadcast TV program to on-demand program according to some embodiments of the present disclosure;

FIG. 5 is a schematic block diagram showing a target playing time point determining module in a device for switching broadcast TV program to on-demand program according to some embodiments of the present disclosure; and

FIG. 6 is a schematic view of a display screen showing a prompt message of switching TV signals in a method and device for switching broadcast TV program to on-demand program according to some embodiments of the present disclosure.

The embodiments of the present disclosure have been clearly illustrated through the drawings and will be described in detail hereinafter. These drawings and text description are not intent in any way to limit the scope of the disclosure, but illustrate the concept of the disclosure for the skilled in the art by reference to specific embodiments.

### DETAILED DESCRIPTION

The present disclosure is described more fully hereinafter with reference to the accompanying drawings so that the objects, technical solutions and advantages of the present disclosure will become more apparent.

It will be understood that, the terms “first”, “second” etc. used herein is to distinguish various elements or parameters with the same name for the convenience. The embodiments of the present disclosure should not be limited by these terms and the specific description of these terms for the embodiments would be omitted hereinafter.

Smart TV, as a more and more popular new television equipment nowadays, does not only have a conventional function of watching TV program of broadcast TV signals, but also have a function of Internet connection to watch network video. The problem proposed in the present disclosure can be addressed by effectively combining the both functions.

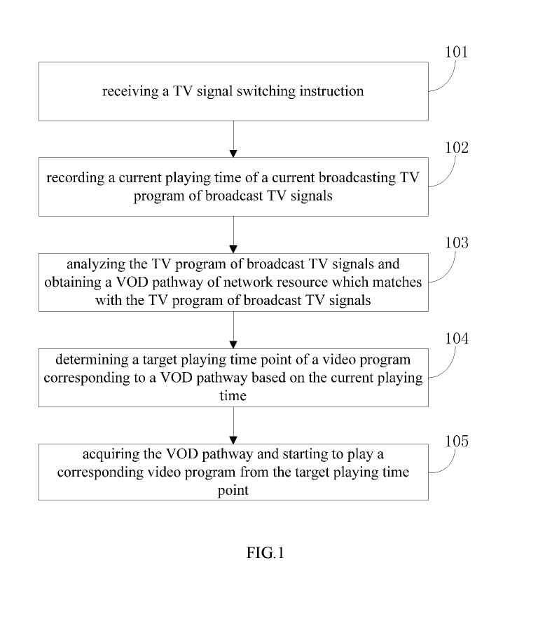

In view of this, the first aspect of the present disclosure provides a method for switching broadcast TV program to on-demand program. As shown in FIG. 1, which is a schematic flow diagram of a method for switching broadcast TV program to on-demand program according to an embodiment of the present disclosure.

The method for switching broadcast TV program to on-demand program includes:
Step 101: receiving a TV signal switching instruction, wherein the TV signal switching instruction refers to an instruction of switching a broadcast TV program to an on-demand network program, and wherein the instruction can be an instruction receiving from a TV remote control device;
Step 102: recording a current playing time (e.g., 11 am) of a current broadcasting TV program of broadcast TV signals;
Step 103: analyzing the TV program of broadcast TV signals (e.g., x^{th} episode of xx TV drama of xx TV station is being played now) and obtaining a VOD pathway of network resource which matches with the TV program of broadcast TV signals (i.e., the pathway of the corresponding episode of the TV drama in the network resource);
Step 104: determining a target playing time point of a video program corresponding to a VOD pathway based on the current playing time; wherein the starting time of the episode (e.g., 10:50 am) can be determined and combined with the current playing time (e.g., 11:00 am) to calculate a played duration (e.g., 10 min) so as to obtain the target playing time point of the episode (e.g., 10th min); and
Step 105: acquiring the VOD pathway and starting to play a corresponding video program from the target playing time point (e.g., from 10th min).

As can be seen from the embodiment, the method and device for switching broadcast TV program to on-demand program provided by the embodiments of the present disclosure, can record the current playing time and find the network resource corresponding to the current broadcasting TV program by responding to the received TV signal switching instruction, and resume to play the corresponding VOD program from the time point when receiving the switching instruction, so that when the broadcast TV program is cut in by advertising spots, the user can search the network resource to resume the playback by himself without waiting for the end of the advertising spots, which may facilitate the user to watch the TV program of interest and save the user's time of waiting for the end of advertising.

However, the conventional smart TV generally receives digital TV signals from a digital STB (Set-Top Box) when playing TV program of broadcast TV signals, but the smart TV itself cannot discern the digital TV signals of different TV stations, so that it cannot be known from the digital TV signals which TV station's program is playing on the smart TV.

Therefore, further, in some alternative embodiments, the Step 103 of analyzing the TV program of broadcast TV signals and obtaining a VOD pathway of network resource which matches with the TV program of broadcast TV signals can further include:
obtaining a station logo of a current broadcasting TV station by analyzing a screen of the TV program of broadcast TV signals, wherein it can be implemented by obtaining a screen shot of the current playing screen on the smart TV and extracting a station logo image from top-left corner of the screen shot, and then finding a station logo matching with the station logo image by image matching algorithms;
acquiring a program list of the TV station corresponding to the station logo based on the obtained station logo; specifically, after obtaining the station logo, the corresponding TV station can be confirmed and the very day's program list of the TV station can be found via network way;
obtaining a program information of the TV program of broadcast TV signals by analyzing the program list (i.e., x^{th} episode of xx TV drama of xx entertaining show will be played in xx period);
obtaining a video program corresponding to the program information by matching in a network media repository (i.e., the x^{th} episode of xx TV drama of xx entertaining show); and
extracting a VOD pathway (network playing pathway) of the video program from the network media repository.

In this way, the network resource corresponding to the current broadcasting TV program of broadcast TV signals can be accurately found.

Furthermore, in other embodiments, the Step 104 further can include the steps of:
acquiring a starting time (e.g., 10:50 am) of the current broadcasting TV program of broadcast TV signals from the program list;
acquiring a played duration (e.g., 10 min) by subtracting the starting time from the current play time (e.g., 11:00 am); and
taking a final time point of the played duration (e.g., 10th min) as the target playing time point.

In this way, the program can be resume to play from the break point of the TV program of broadcast TV signals when the user sends a TV signal switching instruction.

In some alternative embodiments, before the Step 101, the method further can include the steps of:
detecting that the current broadcasting TV program of broadcast TV signals is starting to be cut in by advertising spots;
   specifically, in some alternative embodiments, that the current broadcasting TV program of broadcast TV signals is starting to be cut in by advertising spots can be detected by:
obtaining the advertising period from the program list to pre-determine the time point of advertising; or monitoring the image information of current screen, wherein, for example, a logo of the current playing program will be emerged at bottom-left or bottom-right corner of the screen during broadcasting in general, but the logo will disappear once entering an advertising, so that it can be determined whether an advertising is playing now by monitoring whether there is the logo on the screen in real-time;
sending a prompt message of whether switching the TV signals or not, for prompting the user who is watching the program that it is now an advertising time and whether the user needs to switch to network signals for watching or not.

By adding the steps, it can prompt the user when entering the advertising that the user can choose to switch the TV signals to resume to watch, or automatically prompt the user based on the schedule of advertising shots that the advertising shots is about to be played or is being played and whether the user needs to choose a switching of TV signals for resuming to watch or not, so that it is further convenient for the user to watch TV program.

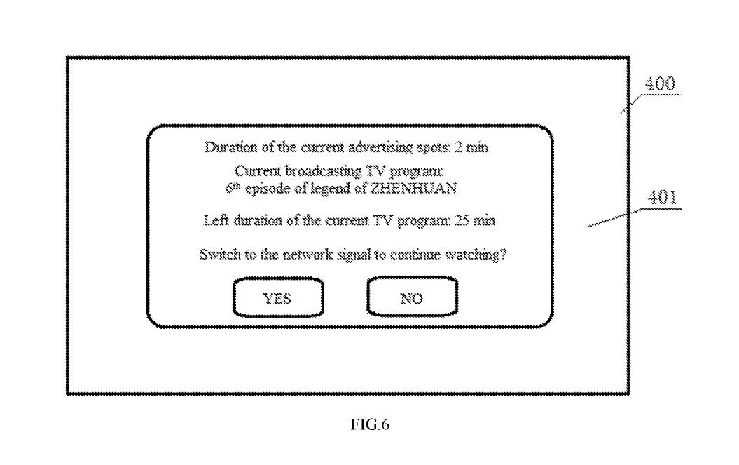

Further, in some embodiments, the prompt message for switching TV signals can further include (referring to FIG. 6, the prompt message 401 for switching TV signals is displayed on the display module 400 of the device):
a duration of the advertising spots (which can be acquired from the program list);
a name of the current broadcasting TV program; and
a left duration of the current broadcasting TV program.

The design of the prompt message including the above-mentioned contents can allow the user to better decide whether the user needs to switch a video. For example, if the advertising duration is only 30 seconds or the current program remains the last 2 minutes (possibly the ending song), the user may not need to switch the signals; but if the advertising duration is 5 minutes or the current program remains 30 minutes before the end, the user may feel like that it is necessary to switch the signals.

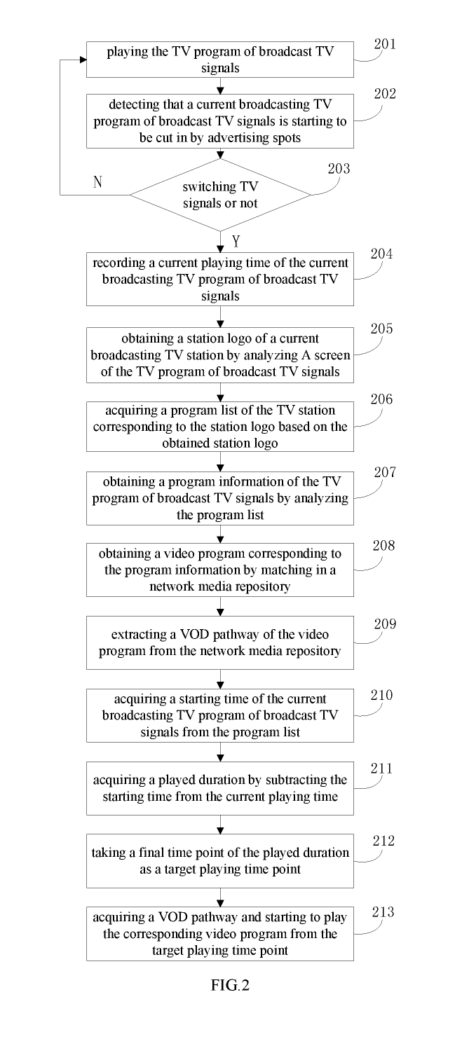

Alternatively, as shown in FIG. 2, it is a schematic flow diagram of a method for switching broadcast TV program to on-demand program according to another embodiment of the present disclosure.

The method for switching broadcast TV program to on-demand program includes the steps of:
Step 201: acquiring broadcast TV signals and playing the corresponding TV program;
Step 202: detecting that a current broadcasting TV program of broadcast TV signals is starting to be cut in by advertising spots now;
Step 203: sending a prompt message of whether switching TV signals or not; if not receiving a TV signal switching instruction, then executing Step 201; if receiving a TV signal switching instruction, then executing Step 204;
Step 204: recording a current playing time of the current broadcasting TV program of broadcast TV signals;
Step 205: obtaining a station logo of a current broadcasting TV station by analyzing a screen of the TV program of broadcast TV signals;
Step 206: acquiring a program list of a TV station corresponding to a station logo based on an obtained station logo;
Step 207: obtaining a program information of the TV program of broadcast TV signals by analyzing the program list;
Step 208: obtaining a video program corresponding to the program information by matching in a network media repository;
Step 209: extracting a VOD pathway of the video program from the network media repository;
Step 210: acquiring a starting time of the current broadcasting TV program of broadcast TV signals from the program list;
Step 211: acquiring a played duration by subtracting the starting time from a current playing time;
Step 212: taking a final time point of the played duration as a target playing time point; and
Step 213: acquiring a VOD pathway and starting to play the corresponding video program from the target playing time point.

As can be seen from the embodiment, the method for switching broadcast TV program to on-demand program provided by the embodiments of the present disclosure, can record the current playing time and find the network resource corresponding to the current broadcasting TV program by responding to the received TV signal switching instruction, and resume to play the corresponding VOD program from the time point when receiving the switching instruction, so that when the broadcast TV program is cut in by advertising spots, the user can search the network resource to resume the playback by himself without the need to wait for the end of the advertising spots, which may facilitate the user to watch the TV program of interest and save the user's time of waiting for the end of advertising. Furthermore, due to addition of a step of sending a prompt message, the user can be reminded to switch the signals or informed of the status information of the current playing TV program, so that the user can better decide whether or not to switch the signals, and the method is convenient to use.

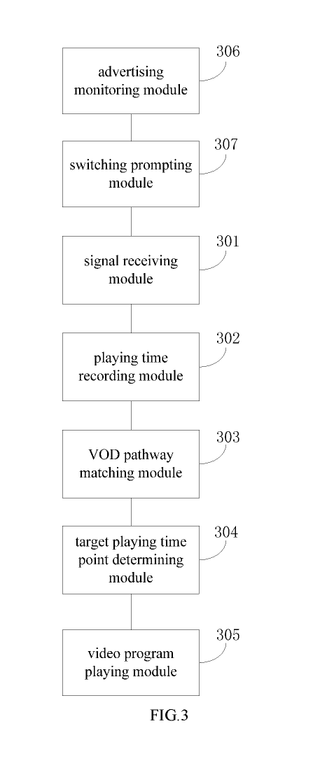

The second aspect of the present disclosure also provides a device (alternatively, it may be a smart TV) for switching broadcast TV program to on-demand program. As shown in FIG. 3, it is a schematic block diagram showing a device for switching broadcast TV program to on-demand program according to an embodiment of the present disclosure.

The device for switching broadcast TV program to on-demand program, including:
a signal receiving module 301 (which may be a receiving module for receiving a signal from a remote control device), for receiving a TV signal switching instruction; wherein the TV signal switching instruction refers to an instruction of switching a broadcast TV program to an on-demand network program, and the instruction can be an instruction from a TV remote control device;
a playing time recording module 302, for recording a current playing time of a current broadcasting TV program of broadcast TV signals;
a VOD pathway matching module 303, for analyzing the TV program of broadcast TV signals and obtaining a VOD pathway of network resource which matches with the TV program of broadcast TV signals;
a target playing time point determining module 304, for determining a target playing time point of a video program corresponding to a VOD pathway based on the current playing time; and
a video program playing module 305, for acquiring the VOD pathway and starting to play a corresponding video program from the target playing time point.

As can be seen from the embodiment, the method and device for switching broadcast TV program to on-demand program provided by the embodiments of the present disclosure, can record the current playing time and find the network resource corresponding to the current broadcasting TV program by responding to the received TV signal switching instruction, and resume to play the corresponding VOD program from the time point when receiving the switching instruction, so that when the broadcast TV program is cut in by advertising spots, the user can search the network resource to resume the playback by himself without the need to wait for the end of the advertising spots, which may facilitate the user to watch the TV program of interest and save the user's time of waiting for the end of advertising.

Each functional module can employ a hardware module or a combination of at least two hardware modules which can achieve the function as described, for example, the signal receiving module 301 can employ an infrared receiver, and the playing time recording module 302, the VOD pathway matching module 303 and the target playing time determining module 304 can be a microprocessor chip independent of each other or one microprocessor chip to complete the three functions, and the video program playing module 305 can be a display module of the device or a display module with a microprocessor, and so on. The hardware modules of these functional modules can be selected and performed for circuit design as required.

However, the conventional smart TV generally receives digital TV signals from a digital STB (Set-Top Box) when playing TV program of broadcast TV signals, but the smart TV itself cannot discern the digital TV signals of different TV stations, so that it cannot be known from the digital TV signals which TV station's program is playing on the smart TV.

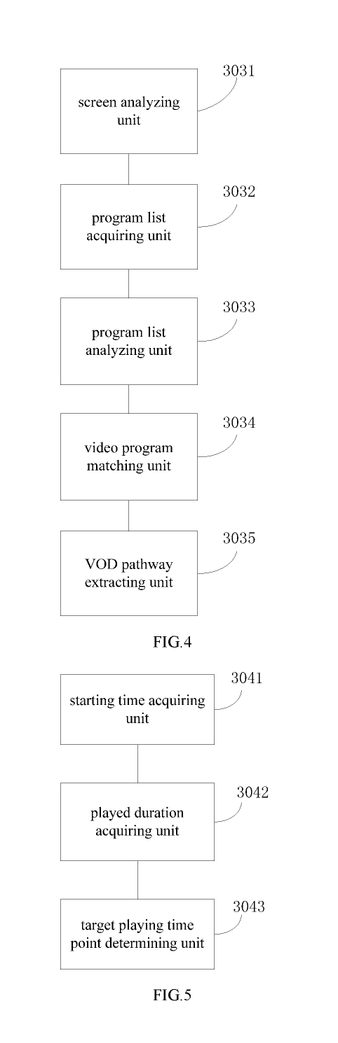

Therefore, in some embodiments, as shown in FIG. 4, the VOD pathway matching module 303 can further includes:
a screen analyzing unit 3031, for obtaining a station logo of a current broadcasting TV station by analyzing a screen of the TV program of broadcast TV signals; wherein it can be implemented by obtaining a screen shot of the current playing screen on the smart TV and extracting a station logo image from top-left corner of the screen shot, and then finding a station logo matching with the station logo image by image matching algorithm;
a program list acquiring unit 3032, for acquiring a program list of the TV station corresponding to the station logo based on the obtained station logo; specifically, after obtaining the station logo, the corresponding TV station can be confirmed and the very day's program list of the TV station can be found via network way;
a program list analyzing unit 3033, for obtaining a program information of the TV program of broadcast TV signals by analyzing the program list; (i.e., x^{th} episode of xx TV drama of xx entertaining show will be played in xx period);
a video program matching unit 3034, for obtaining a video program corresponding to the program information by matching in a network media repository (i.e., the x^{th} episode of xx TV drama of xx entertaining show);
a VOD pathway extracting unit 3035, for extracting a VOD pathway of the video program from the network media repository.

In this way, the network resource corresponding to the current playing broadcasting TV program of broadcast TV signals can be accurately found.

Furthermore, in some embodiments, as shown in FIG. 5, the target playing time point determining module 304 can further includes:
a starting time acquiring unit 3041, for acquiring a starting time (e.g., am 10:50) of the current broadcasting TV program of broadcast TV signals from the program list;
a played duration acquiring unit 3042, for acquiring a played duration (e.g., 10 min) by subtracting the starting time from the current playing time; and
a target playing time point determining unit 3043, for taking a final time point of the played duration (e.g., 10th min) as a target playing time point.

In this way, the program can be resume to play from the break point of the TV program of broadcast TV signals when the user sends a TV signal switching instruction.

Alternatively, in some embodiments, as shown in FIG. 3, the device can further includes:
an advertising monitoring module 306, for detecting that the current broadcasting TV program of broadcast TV signals is starting to be cut in by advertising spots;
   specifically, in some alternative embodiments, the current broadcasting TV program of broadcast TV signals is starting to be cut in by advertising spots can be detected by: obtaining the advertising period from the program list to predetermine the time point of advertising; or monitoring the image information of current screen, wherein, for example, a logo of the current playing program will be emerged at bottom-left or bottom-right corner of the screen during broadcasting in general, but the logo will disappear once entering an advertising, so that it can be determined whether an advertising is played currently by monitoring whether there is the logo on the screen in real-time;
a switching prompting module 307, for sending a prompt message of whether switching the TV signals or not, for prompting the user who is watching the program that it is now an advertising time and whether the user need to switch to network signals for watching.

By adding the steps, it can prompt the user when entering the advertising that the user can choose to switch the TV signals to resume to watch, or automatically prompt the user based on the schedule of advertising shots that the advertising shots is about to be played or is being played and whether the user needs to choose a switching of TV signals for resuming to watch or not, so that it is further convenient for the user to watch TV program.

Further, in some preferred embodiments, the prompt message for switching TV signals can further include (referring to FIG. 6, the prompt message 401 for switching TV signals is displayed on the display module 400 of the device):
a duration of the advertising spots (which can be acquired from the program list);
a name of the current broadcasting TV program; and
a left duration of the current broadcasting TV program.

The design of the prompt message including the above-mentioned contents can allow the user to better decide whether the user needs to switch a video. For example, if the advertising duration is only 30 seconds or the current program remains the last 2 minutes (possibly the ending song), the user may not need to switch the signals; but if the advertising duration is 5 minutes or the current program remains 30 minutes before the end, the user may feel like that it is necessary to switch the signals.

Hereinafter, it is described how to apply the device for switching broadcast TV program to on-demand program provided by the present disclosure into the method for switching broadcast TV program to on-demand program. As shown in FIG. 2, it is a schematic flow diagram of a method for switching broadcast TV program to on-demand program according to another embodiment of the present disclosure.

The method for switching broadcast TV program to on-demand program includes the steps of:
Step 201: the video program playing module 305 acquiring broadcast TV signals and playing the corresponding TV program;
Step 202: the advertising monitoring module 306 detecting that a current broadcasting TV program of broadcast TV signals is starting to be cut in by advertising spots now;
Step 203: the switch prompting module 307 sending a prompt message of whether switching TV signals or not; if the signal receiving module 301 does not receive a TV signal switching instruction, then executing Step 201; if the signal receiving module 301 receives a TV signal switching instruction, then executing Step 204;
Step 204: the playing time recording module 302 recording a current playing time of the current broadcasting TV program of broadcast TV signals;
Step 205: the screen analyzing unit 3031 obtaining a station logo of a current broadcasting TV station by analyzing a screen of the TV program of broadcast TV signals;
Step 206: the program list acquiring unit 3032 acquiring a program list of a TV station corresponding to a station logo based on an obtained station logo;
Step 207: the program list analyzing unit 3033 obtaining a program information of the TV program of broadcast TV signals by analyzing the program list;
Step 208: the video program matching unit 3034 obtaining a video program corresponding to the program information by matching in a network media repository;
Step 209: the VOD pathway extracting unit 3035 extracting a VOD pathway of the video program from the network media repository;
Step 210: the starting time acquiring unit 3041 acquiring a starting time of the current broadcasting TV program of broadcast TV signals from the program list;
Step 211: the played duration acquiring unit 3042 acquiring a played duration by subtracting the starting time from the current playing time;
Step 212: the target playing time point determining unit 3043 taking a final time point of the played duration as the target playing time point; and
Step 213: the video program playing module 305 acquiring a VOD pathway and starting to play the corresponding video program from the target playing time point.

Another aspect of the present disclosure further provides a device, as an embodiment including:
one or more processor(s), optionally, the one or more processor(s) is/are used for executing the steps defined by the methods of any one or more above-described embodiments; and
a memory for storing one or more operating instruction(s);
   wherein the one or more processor(s) is/are configured to acquire the operation instruction from the memory to execute the steps of:
receiving a TV signal switching instruction;
recording a current playing time of a current broadcasting TV program of broadcast TV signals;
analyzing the TV program of broadcast TV signals and obtaining a VOD (Video on-Demand) pathway of network resource which matches with the TV program of broadcast TV signals;
determining a target playing time point of a video program corresponding to a VOD pathway based on the current playing time; and
acquiring the VOD pathway and starting to play a corresponding video program from the target playing time point.

In some alternative embodiments, the processor is further used for executing the steps of:
obtaining a station logo of a current broadcasting TV station by analyzing a screen of the TV program of broadcast TV signals;
acquiring a program list of the TV station corresponding to the station logo based on the obtained station logo;
obtaining a program information of the TV program of broadcast TV signals by analyzing the program list;
obtaining a video program corresponding to the program information by matching in a network media repository; and
extracting a VOD pathway of the video program from the network media repository.

In some alternative embodiments, the processor is further used for executing the steps of:
acquiring a starting time of the current broadcasting TV program of broadcast TV signals from the program list;
acquiring a played duration by subtracting the starting time from the current playing time; and
taking a final time point of the played duration as a target playing time point.

In some alternative embodiments, the process is further used for executing the steps of:
detecting that the current broadcasting TV program of broadcast TV signals is starting to be cut in by advertising spots; and
sending a prompt message of whether switching the TV signals or not.

In some alternative embodiments, the prompt message of whether switching the TV signals or not includes:
a duration of the advertising spots;
a name of the current broadcasting TV program; and
a left duration of the current broadcasting TV program.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to implement the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical sections, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for switching broadcast TV program to on-demand program, comprising:
receiving a TV signal switching instruction;
recording a current playing time of a current broadcasting TV program of broadcast TV signals;
analyzing the TV program of broadcast TV signals and obtaining a VOD (Video on-Demand) pathway of network resource which matches with the TV program of broadcast TV signals;
determining a target playing time point of a video program corresponding to a VOD pathway based on the current playing time; and
acquiring the VOD pathway and starting to play a corresponding video program from the target playing time point.

2. The method according to claim 1, wherein the step of analyzing the TV program of broadcast TV signals and obtaining a VOD pathway of network resource which matches with the TV program of broadcast TV signals comprises:
obtaining a station logo of a current broadcasting TV station by analyzing a screen of the TV program of broadcast TV signals;
acquiring a program list of the TV station corresponding to the station logo based on the obtained station logo;
obtaining a program information of the TV program of broadcast TV signals by analyzing the program list;
obtaining a video program corresponding to the program information by matching in a network media repository;
extracting a VOD pathway of the video program from the network media repository.

3. The method according to claim 2, wherein the step of determining a target playing time point of a video program corresponding to a VOD pathway based on the current playing time comprises:
acquiring a starting time of the current broadcasting TV program of broadcast TV signals from the program list;
acquiring a played duration by subtracting the starting time from the current playing time;
taking a final time point of the played duration as a target playing time point.

4. The method according to claim 1, wherein before the step of receiving a TV signals switching instruction, the method further comprises:
detecting that the current broadcasting TV program of broadcast TV signals is starting to be cut in by advertising spots;
sending a prompt message of whether switching the TV signals or not.

5. The method according to claim 4, wherein the prompt message of whether switching the TV signals or not comprises:
a duration of the advertising spots;
a name of the current broadcasting TV program; and
a left duration of the current broadcasting TV program.

6. A device for switching broadcast TV program to on-demand program, comprising:
a signal receiving module, for receiving a TV signal switching instruction;
a playing time recording module, for recording a current playing time of a current broadcasting TV program of broadcast TV signals;
a VOD pathway matching module, for analyzing the TV program of broadcast TV signals and obtaining a VOD pathway of network resource which matches with the TV program of broadcast TV signals;
a target playing time point determining module, for determining a target playing time point of a video program corresponding to a VOD pathway based on the current playing time; and
a video program playing module, for acquiring the VOD pathway and starting to play a corresponding video program from the target playing time point.

7. The device according to claim 6, wherein the VOD pathway matching module comprises:
a screen analyzing unit, for obtaining a station logo of a current broadcasting TV station by analyzing a screen of the TV program of broadcast TV signals;
a program list acquiring unit, for acquiring a program list of the TV station corresponding to the station logo based on the obtained station logo;
a program list analyzing unit, for obtaining a program information of the TV program of broadcast TV signals by analyzing the program list;
a video program matching unit, for obtaining a video program corresponding to the program information by matching in a network media repository;
a VOD pathway extracting unit, for extracting a VOD pathway of the video program from the network media repository.

8. The device according to claim 7, wherein the target playing time point determining module comprises:
a starting time acquiring unit, for acquiring a starting time of the current broadcasting TV program of broadcast TV signals from the program list;
a played duration acquiring unit, for acquiring a played duration by subtracting the starting time from the current playing time; and
a target playing time point determining unit, for taking a final time point of the played duration as a target playing time point.

9. The device according to claim 6, wherein the device further comprises:
an advertising monitoring module, for detecting that the current broadcasting TV program of broadcast TV signals is starting to be cut in by advertising spots; and
a switching prompting module, for sending a prompt message of whether switching of the TV signals.

10. The device according to claim 9, wherein the prompt message of whether switching the TV signals or not comprises:
a duration of the advertising spots;
a name of the current broadcasting TV program; and
a left duration of the current broadcasting TV program.

11. A device, comprising:
one or more processor(s); and
a memory for storing one or more operating instruction(s);
wherein the one or more processor(s) is/are configured to acquire the operation instruction from the memory to execute the steps of:
receiving a TV signal switching instruction;
recording a current playing time of a current broadcasting TV program of broadcast TV signals;
analyzing the TV program of broadcast TV signals and obtaining a VOD (Video on-Demand) pathway of network resource which matches with the TV program of broadcast TV signals;
determining a target playing time point of a video program corresponding to a VOD pathway based on the current playing time; and
acquiring the VOD pathway and starting to play a corresponding video program from the target playing time point.

12. The device according to claim 11, wherein the processor is further used for executing the steps of:
obtaining a station logo of a current broadcasting TV station by analyzing a screen of the TV program of broadcast TV signals;
acquiring a program list of the TV station corresponding to the station logo based on the obtained station logo;
obtaining a program information of the TV program of broadcast TV signals by analyzing the program list;
obtaining a video program corresponding to the program information by matching in a network media repository; and
extracting a VOD pathway of the video program from the network media repository.

13. The device according to claim 12, wherein the processor is further used for executing the steps of:
acquiring a starting time of the current broadcasting TV program of broadcast TV signals from the program list;
acquiring a played duration by subtracting the starting time from the current playing time; and
taking a final time point of the played duration as a target playing time point.

14. The device according to claim 11, wherein the process is further used for executing the steps of:
detecting that the current broadcasting TV program of broadcast TV signals is starting to be cut in by advertising spots; and
sending a prompt message of whether switching the TV signals or not.

15. The device according to claim 14, wherein the prompt message of whether switching the TV signals or not comprises:
a duration of the advertising spots;
a name of the current broadcasting TV program; and
a left duration of the current broadcasting TV program.
